(19) United States
(12) Patent Application Publication
(10) Pub. No.: US 2026/0075660 A1
(43) Pub. Date: Mar. 12, 2026

(54) HIGH PRIORITY EDCA WITH AP PARTICIPATION

(71) Applicant: Samsung Electronics Co., Ltd., Suwon-si (KR)

(72) Inventors: Yue Qi, Plano, TX (US); Peshal Nayak, Plano, TX (US); Boon Loong Ng, Plano, TX (US); Vishnu Vardhan Ratnam, Frisco, TX (US); Bilal Sadiq, Plano, TX (US); Rubayet Shafin, Frisco, TX (US)

(21) Appl. No.: 19/318,259

(22) Filed: Sep. 3, 2025

Related U.S. Application Data
(60) Provisional application No. 63/691,785, filed on Sep. 6, 2024.
(60) Provisional application No. 63/703,005, filed on Oct. 3, 2024.
(60) Provisional application No. 63/712,095, filed on Oct. 25, 2024.
(60) Provisional application No. 63/778,950, filed on Mar. 27, 2025.
(60) Provisional application No. 63/781,781, filed on Apr. 1, 2025.

(51) Int. Cl. H04W 74/08; H04W 74/00; H04W 74/04; H04W 74/0816

(52) U.S. Cl. CPC H04W 74/0875; H04W 74/002; H04W 74/04; H04W 74/0816

(57) ABSTRACT

An access point (AP) includes a transceiver. The transceiver is configured to at least one of (i) receive, during a high priority (Hip) enhanced distributed channel access (EDCA) contention period, from each of one or more stations (STAs), a respective first defer signal (DS) indicating that a respective STA has low latency traffic (LLT), and (ii) transmit, during the Hip EDCA contention period, a second DS indicating that the AP has LLT. The AP also includes a processor operably coupled to the transceiver. The processor is configured to manage the LLT for each of the one or more STAs.

### CROSS-REFERENCE TO RELATED APPLICATION(S) AND CLAIM OF PRIORITY

This application claims priority under 35 U.S.C. § 119(e) to U.S. Provisional Patent Application No. 63/691,785 filed on Sep. 6, 2024, U.S. Provisional Patent Application No. 63/703,005 filed on Oct. 3, 2024, U.S. Provisional Patent Application No. 63/712,095 filed on Oct. 25, 2024, U.S. Provisional Patent Application No. 63/778,950 filed on Mar. 27, 2025, and U.S. Provisional Patent Application No. 63/781,781 filed on Apr. 1, 2025. The above-identified provisional patent applications are hereby incorporated by reference in their entirety.

### TECHNICAL FIELD

This disclosure relates generally to wireless networks. More specifically, this disclosure relates to high priority enhanced distributed channel access (EDCA) with access point (AP) participation.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for high priority EDCA with AP participation.

In one embodiment, an access point (AP) is provided. The AP includes a transceiver. The transceiver is configured to (i) receive, during a high priority (Hip) enhanced distributed channel access (EDCA) contention period, from each of one or more stations (STAs), a respective first defer signal (DS) indicating that a respective STA has low latency traffic (LLT), and (ii) transmit, during the Hip EDCA contention period, a second DS indicating that the AP has LLT. The AP also includes a processor operably coupled to the transceiver. The processor is configured to manage the LLT for each of the one or more STAs.

In another embodiment, a STA is provided. The STA includes a processor, and a transceiver operably coupled to the processor. The transceiver is configured to (i) transmit, during a Hip EDCA contention period, a first DS indicating that the STA has LLT, and (ii) receive, during the Hip EDCA contention period, a second DS indicating that an AP has LLT.

In yet another embodiment, a method of operating an AP is provided. The method includes receiving, during a Hip EDCA contention period, from each of one or more STAs, a respective first DS indicating that a respective STA has LLT. The method also includes transmitting, during the Hip EDCA contention period, a second DS indicating that the AP has LLT, and managing the LLT for each of the one or more STAs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3A illustrates an example of DL LLT according to embodiments of the present disclosure;

FIG. 3B illustrates an example of UL LLT according to embodiments of the present disclosure;

FIG. 4 illustrates an example of a congested network according to embodiments of the present disclosure;

FIG. 5 illustrates an example method for obtaining a quick TXOP according to embodiments of the present disclosure;

FIG. 6 illustrates an example long-term quick TXOP solution according to embodiments of the present disclosure;

FIG. 7 illustrates an example short-term quick TXOP solution according to embodiments of the present disclosure;

FIG. 8 illustrates an example quick TXOP with DS solution according to embodiments of the present disclosure;

FIG. 9 illustrates an example of signaling and frame exchange for LLT with a quick TXOP according to embodiments of the present disclosure;

FIG. 10 illustrates an example of signaling and frame exchange for LLT with a quick TXOP and DS according to embodiments of the present disclosure;

FIG. 11 illustrates an example of DL LLT in a quick TXOP according to embodiments of the present disclosure;

FIG. 12 illustrates an example of UL LLT in a quick TXOP according to embodiments of the present disclosure;

FIG. 13 illustrates an example of LLT in a quick TXOP according to embodiments of the present disclosure;

FIG. 14 illustrates an example of multiple types of LLT in a quick TXOP according to embodiments of the present disclosure;

FIG. 15 illustrates an example of Hip EDCA with AP control according to embodiments of the present disclosure;

FIG. 16 illustrates an example method for a Hip EDCA mode B according to embodiments of the present disclosure;

FIG. 17 illustrates an example of Hip EDCA mode B according to embodiments of the present disclosure;

FIG. 18 illustrates an example of a Hip EDCA contention period according to embodiments of the present disclosure;

FIG. 19 illustrates an example solution for Hip EDCA mode selection according to embodiments of the present disclosure;

FIG. 20 illustrates an example of Hip EDCA mode B with a single DS according to embodiments of the present disclosure;

FIG. 21 illustrates an example of Hip EDCA mode B with a multiple DSs according to embodiments of the present disclosure;

FIG. 22 illustrates an example P-EDCA disablement solution according to embodiments of the present disclosure;

FIG. 23 illustrates an example of consecutive DS attempts and a P-EDCA contention period according to embodiments of the present disclosure;

FIG. 24 illustrates an example of TXOP extension using dynamic fragmentation according to embodiments of the present disclosure; and

FIG. 25 illustrates an example method for Hip EDCA with AP support according to embodiments of the present disclosure.

### DETAILED DESCRIPTION

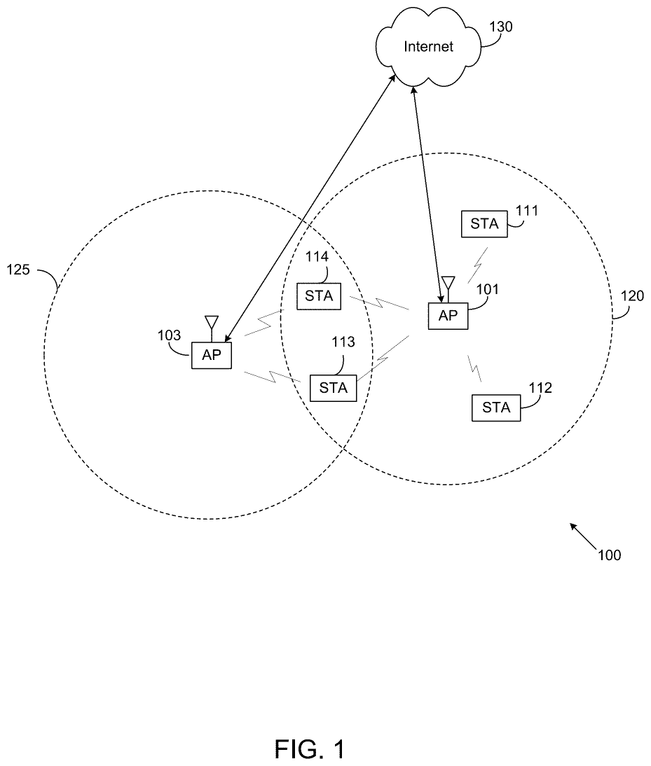

FIGS. 1 through 25, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

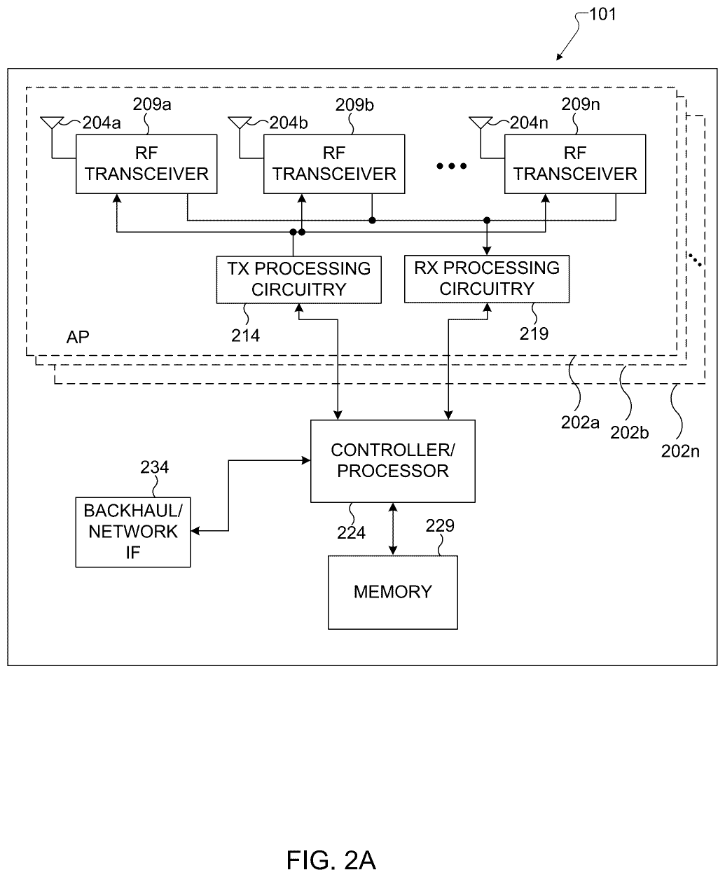

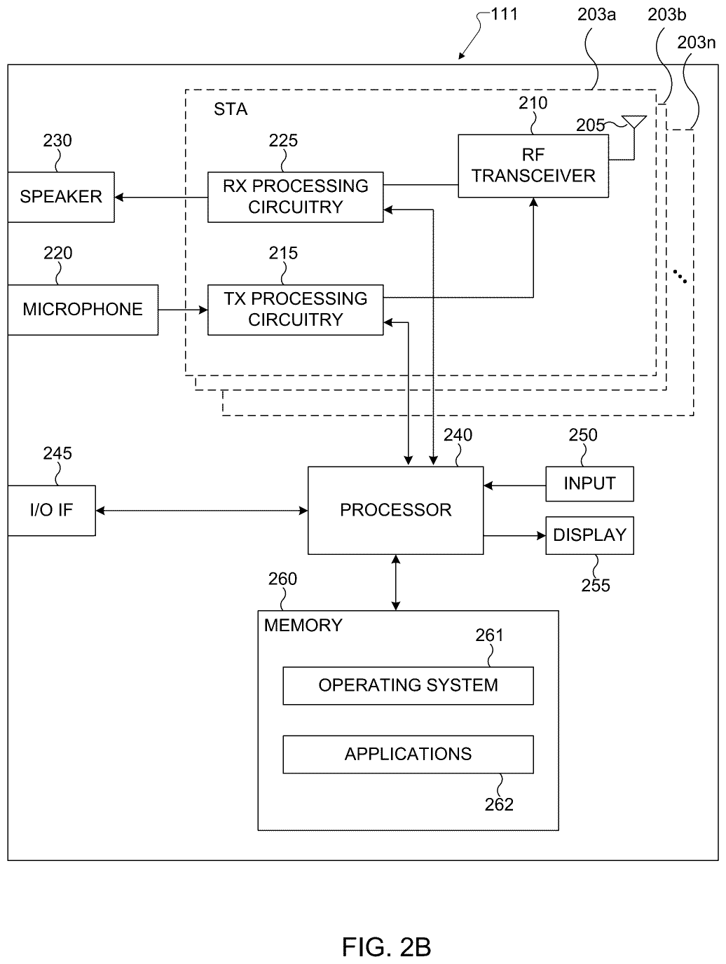

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MILD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MILD 101, various changes may be made to FIG. 2A. For example, the AP MILD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Recently, a significant focus has been given to reducing the channel access delay for low-latency traffic (LLT) required by real-time applications (RTAs) in wireless networks. For example, it has been proposed to define at least one mode of operation capable of improving the tail of the latency distribution and jitter compared to Extremely High Throughput MAC/PHY operation. Reducing the channel access delay for LLT is desirable for several reasons:
New applications (including metaverse, augmented and virtual reality, robotics, industrial automation for industrial IoT, logistics and smart agriculture) have lower latency demands.
Lower latency leads to a better customer experience (especially worst-case latency/jitter mattering).
Low latency communication is becoming an essential building block for RTAs. Some use cases may necessitate less than 5 ms of latency and 2 ms of jitter.

Current wireless networks may not support traffic which arrives late in a transmission opportunity (TXOP) seeking an opportunity to be scheduled. Hower, scheduling such traffic within the current TXOP or at most one-time channel access is beneficial for several scenarios including:
The traffic is LLT arriving near the end of the TXOP.
A preemption may prevent regular traffic from being scheduled.
A preemption may prevent LLT from completing transmission within the TXOP.
A higher access category (AC) requests transmission in the next PPDU, but the TXOP is about to end.

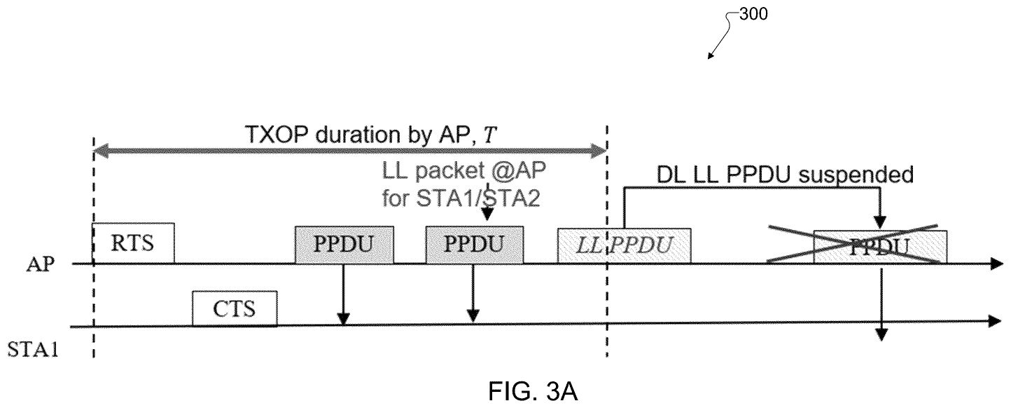

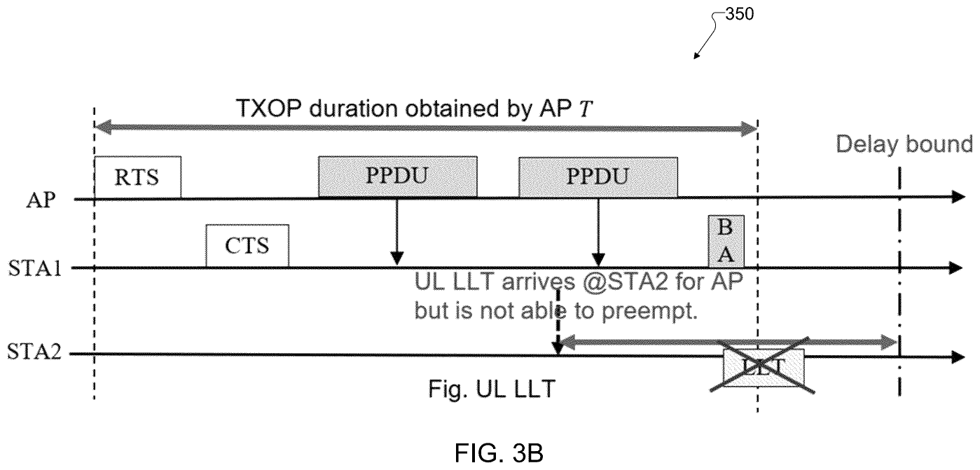

Examples of the above scenarios are shown in FIG. 3A and FIG. 3B.

FIG. 3A illustrates an example of downlink (DL) LLT 300 according to embodiments of the present disclosure. The embodiment of DL LLT of FIG. 3A is for illustration only. Different embodiments of DL LLT could be used without departing from the scope of this disclosure.

In example 300, an AP is transmitting packets to a STA (“STA1”) during a TXOP duration of the AP. Before the TXOP duration ends, LLT arrives at the AP for STA1 as a low latency (LL) physical layer protocol data unit (PPDU) whose length exceeds the remainder of the TXOP duration. Therefore, the LLT cannot be transmitted within the TXOP, and transmission of the LLT is suspended.

Although FIG. 3A illustrates one example 300 of DL LLT, various changes may be made to FIG. 3A. For example, various changes to the TXOP duration could be made, etc. according to particular needs.

FIG. 3B illustrates an example of uplink (UL) LLT 350 according to embodiments of the present disclosure. The embodiment of UL LLT of FIG. 3B is for illustration only. Different embodiments of UL LLT could be used without departing from the scope of this disclosure.

In example 350, an AP is transmitting a long PPDU to a first STA (“STA1”) during a TXOP duration of the AP. Before the TXOP duration ends, LLT arrives at a second station (“STA2”) for the AP. However, STA2 is unable to preempt the AP during the long PPDU. Therefore, the LLT cannot be transmitted within the TXOP, and transmission of the LLT is suspended.

Although FIG. 3B illustrates one example 350 of UL LLT, various changes may be made to FIG. 3B. For example, various changes to the TXOP duration could be made, etc. according to particular needs.

Another problematic scenario is when LLT arrives during a long PPDU transmission, and the LLT may expire before the end of the TXOP. For example, for TXOP duration of 8 ms and a delay bound (DB) of 5 ms, if the LLT does not transmit within the current TXOP, the LLT may expire. Therefore, the LLT needs to be served before the DB which is within the current TXOP. Examples of these scenarios include:
An AP or TXOP holder has started a long PPDU, and may not support preemption. Therefore, the LLT may expire before it is scheduled.
An AP or TXOP holder has started a long PPDU and is not allowed to be interrupted (e.g., a quality of service [QoS] LL PPDU), and preemption will be scheduled late after the delay bound.

Various embodiments of the present disclosure provide mechanisms for scheduling LLT that arrives late within a TXOP. This may be referred to herein as quick TXOP operation.

In some scenarios, a STA may suffer from long channel acquisition and occupying time, resulting in long tail latency. Due to bad mad management, a latency worse-case bound may expire before a STA with prioritized access can win the high priority contention window to transmit its LLT. For example:
If latency bounds are fast approaching or soon to expire and LL STAs have not won the channel yet (e.g., some of XR streams with 2-5 ms latency bounds).
A large number of contenders with the same urgent ACs may cause deterioration due to collision and/or packet loss.
Some STAs may have a long channel occupying time or long service of prioritized-enhanced distributed channel access (P-EDCA).

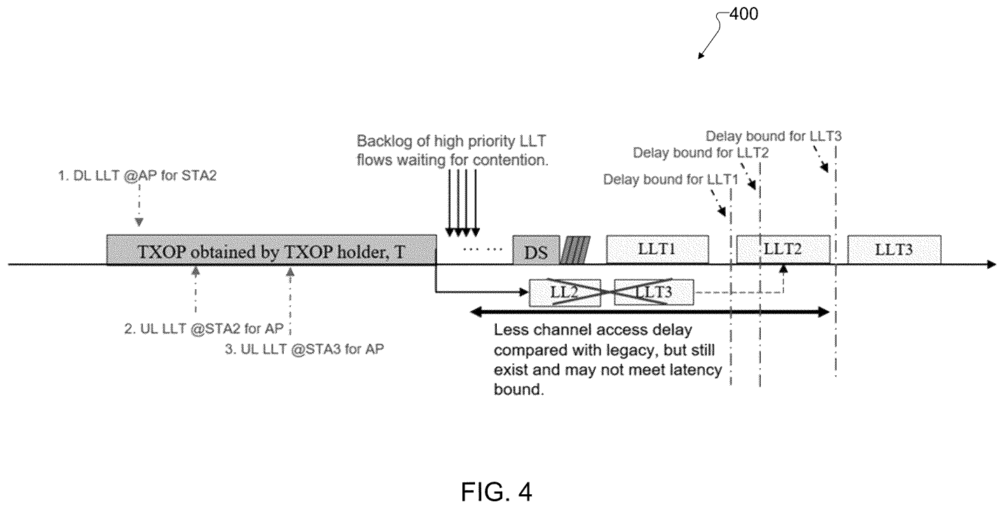

FIG. 4 illustrates an example of a congested network 400 according to embodiments of the present disclosure. The embodiment of a congested network of FIG. 4 is for illustration only. Different embodiments of a congested network could be used without departing from the scope of this disclosure.

In the congested network of FIG. 4, there are multiple types of LLT that arrive during the current TXOP, in which the TXOP is also contended by a LL STA with high priority (Hip) EDCA. The LLT includes (i) DL LLT at the AP for STA2; (ii) UL LLT at STA2 for the AP; (iii) UL LLT at STA3 for the AP, etc. Though not shown, example 400 could also include a large backlog of LLT flows from other STAs waiting for Hip contention after the TXOP. Only some of the LLT STAs may be able to send a DS. For example, LLT1 may send a DS and be scheduled within its delay bound, while LL2 and LL3 may not be able to win in the Hip contention and may not transmit successfully within the latency boundaries.

Although FIG. 4 illustrates one example of a congested network 400, various changes may be made to FIG. 4. For example, various changes to the delay bounds could be made, etc. according to particular needs.

Various embodiments of the present disclosure provide mechanisms to reduce LLT backlog and long tail latency. This may be referred to herein as high priority EDCA with AP support.

As noted above, various embodiments of the present disclosure provide mechanisms for scheduling LLT that arrives late within a TXOP.

In some embodiments, an AP or a TXOP holder may obtain another TXOP without contention. In some embodiments, the AP or the TXOP holder may obtain a follow-up TXOP after the current TXOP plus a distributed coordination function (DCF) interframe space (DIFS) duration. In embodiments, such as these, the follow-up TXOP may be referred to as a quick TXOP.

In some embodiments, the TXOP holder may obtain a quick TXOP when there is a need to transmit LLT either from the TXOP holder, a TXOP responder, or a third party.

In some embodiments, a non-TXOP holder with LLT (e.g., a TXOP responder or a third party for preemption) may indicate a preemption request during the current TXOP.

In some embodiments, a non-TXOP holder with LLT, (e.g., a TXOP responder or a third party) may indicate a preemption request before the current TXOP.

In some embodiments, the TXOP holder may extend the current TXOP when there is LLT available for transmission either from the TXOP holder, a TXOP responder, or a third party.

In some embodiments, the TXOP holder may access a channel without contention if the TXOP holder intends to extend the channel.

In some embodiments, an LL STA may access a channel without contention if the LL STA intends to transmit in the current and next TXOP.

In some embodiments, a quick TXOP is intended to postpone LLT before a delay bound of the LLT.

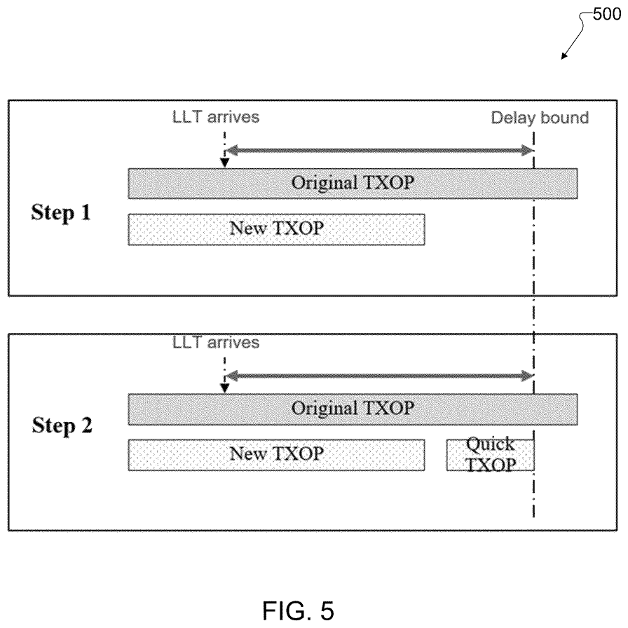

In some embodiments, a quick TXOP may be obtained as shown in FIG. 5

FIG. 5 illustrates an example method 500 for obtaining a quick TXOP according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for obtaining a quick TXOP could be used without departing from the scope of this disclosure.

In the Example of FIG. 5, method 500 begins at Step 1. At Step 1, an AP or a TXOP holder shortens an original TXOP. In some embodiments, when considering a long-term LLT transmission, the AP or TXOP holder may set a TXOP limit T to a value less than a delay bound d, (d≥T). For example, if the delay bound is 5 ms, then the AP or TXOP holder may set the TXOP time limit T as 3 ms. In some embodiments, when considering a short-term, more dynamic LLT transmission, the AP or TXOP holder may choose to end the TXOP (e.g., by sending a contention free [CF]-end frame) to terminate or shorten the TXOP.

At Step 2, the AP or TXOP holder quickly obtains a follow-up TXOP (referred to herein as a quick TXOP) after the end of the first shortened TXOP. During the quick TXOP, the AP or TXOP holder serves the LLT arriving in the previous (shortened) TXOP.

Although FIG. 5 illustrates one example method 500 for obtaining a quick TXOP, various changes may be made to FIG. 5. For example, while shown as a series of steps, various steps in FIG. 5 could overlap, occur in parallel, occur in a different order, occur any number of times, be omitted, or replaced by other steps.

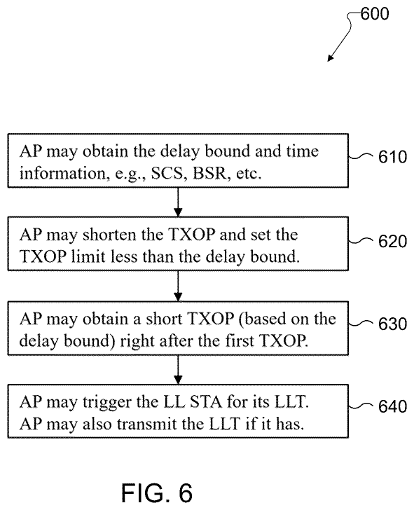

In some embodiments, before an AP or TXOP holder obtains a quick TXOP, the AP or TXOP holder may first obtain some information from an LL STA (e.g., time information, the delay bound, buffer status, etc.). In embodiments such as these, the AP or TXOP holder and the LL STA may exchange the information via stream classification service (SCS), buffer status reports (BSR), etc. Based on the information, when the AP or TXOP holder obtains a TXOP, the AP or TXOP holder may consider setting the first TXOP with a short length which is less than or equal to the delay bound. In this manner, when the LLT traffic arrives for an LL STA, the AP or TXOP holder may then obtain a quick TXOP after the first TXOP. During the quick TXOP, the AP or TXOP holder may trigger the LL STA for LLT transmission. The AP or TXOP holder may also transmit the LLT to other STAs, or share the TXOP for a peer-to-peer (P2P) transmission or coexistence (co-ex) transmission. An example framework for a long-term LLT solution is shown in FIG. 6.

FIG. 6 illustrates an example long-term quick TXOP solution 600 according to embodiments of the present disclosure. An embodiment of the solution illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a long-term quick TXOP solution could be used without departing from the scope of this disclosure.

In the example of FIG. 6, solution 600 is described as performed by an AP. However, it should be understood that solution 600 could be performed by any TXOP holder.

Solution 600 begins at step 610. At step 610, the AP may obtain delay bound and time information for an LLT STA via SCS, BSR, etc.

At step 620, the AP may shorten a TXOP and set the TXOP limit less than the delay bound.

At step 630, the AP may obtain a short TXOP (based on the delay bound) after the first TXOP.

At step 640, the AP may trigger the LL STA to transmit the LL STA's LLT within the short TXOP. The AP may also transmit any LLT of the AP within the short TXOP.

Although FIG. 6 illustrates one example long-term quick TXOP solution 600, various changes may be made to FIG. 6. For example, while shown as a series of steps, various steps in FIG. 6 could overlap, occur in parallel, occur in a different order, occur any number of times, be omitted, or replaced by other steps.

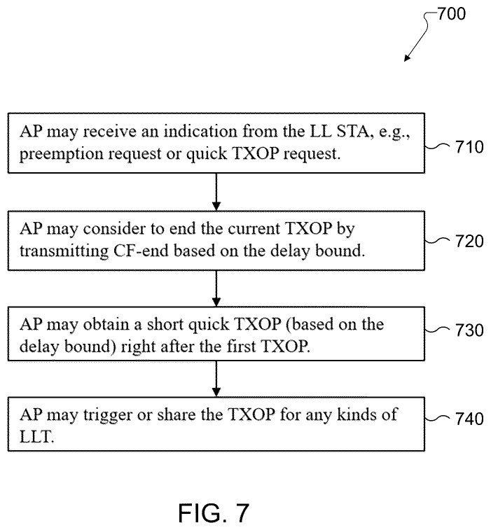

In some embodiments, an AP or TXOP holder may obtain an original TXOP, and then receive LLT. In embodiments such as these, the LLT may include an indication of a delay bound, buffer status, etc. of the associated LL STA for the AP or TXOP holder. Based on the information, the AP or TXOP holder may decide to terminate the original TXOP by sending a SC-end frame. After the termination of the original TXOP, the AP or TXOP holder may obtain a quick TXOP after a period of time without contention. During the quick TXOP, the AP or TXOP may trigger the LL STA to transmit its LLT, transmit the LLT to other STAs, or share the TXOP for a P2P or co-ex transmission. An example framework of a short-term LLT solution is shown in FIG. 7

FIG. 7 illustrates an example short-term quick TXOP solution 700 according to embodiments of the present disclosure. An embodiment of the solution illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a short-term quick TXOP solution could be used without departing from the scope of this disclosure.

In the example of FIG. 7, solution 700 is described as performed by an AP. However, it should be understood that solution 700 could be performed by any TXOP holder.

Solution 700 begins at step 710. At step 710, the AP may receive an indication from an LL STA such as a preemption request or a quick TXOP request.

At step 720, the AP may consider ending the current TXOP by transmitting a CF-end frame based on a delay bound of the LL STA.

At step 730, the AP may obtain a short TXOP (based on the delay bound) after the first TXOP.

At step 740, the AP may trigger or share the quick TXOP for any kind of LLT.

Although FIG. 7 illustrates one example short-term quick TXOP solution 700, various changes may be made to FIG. 7. For example, while shown as a series of steps, various steps in FIG. 7 could overlap, occur in parallel, occur in a different order, occur any number of times, be omitted, or replaced by other steps.

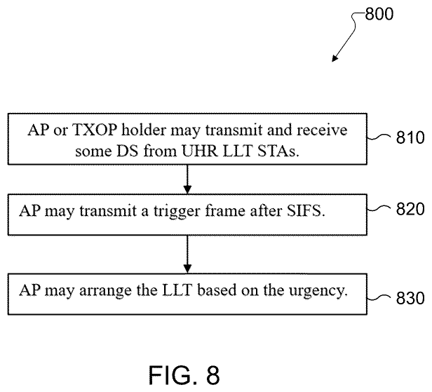

In some embodiments, a quick TXOP can be activated when ultra-high reliability (UHR STAs) send defer signals (DSs) when they have LLT. For example, the STAs may send DSs to indicate the LLT. The DSs can be CTS frames with UHR LLT indications and sent after a DIFS. For example, a bit 1 in the UHR element can indicate that a STA has LLT. A bit 0 may indicate no LLT and may not be sent after a DIFS. After a short interframe space (SIFS) of the DS, the AP or the TXOP holder may transmit a frame (e.g., a trigger frame). A framework for a quick TXOP with DS is shown in FIG. 8.

FIG. 8 illustrates an example quick TXOP with DS solution 800 according to embodiments of the present disclosure. An embodiment of the solution illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a quick TXOP with DS solution could be used without departing from the scope of this disclosure.

In the example of FIG. 8, solution 800 is described as performed by an AP. However, it should be understood that solution 800 could be performed by any TXOP holder.

Solution 800 begins at step 810. At step 810, the AP may transmit and receive some DSs from UHR LLT STAs.

At step 820, the AP may transmit a trigger frame after a SIFS.

At step 830, the AP may obtain arrange the LLT of the UHR LLT STAs based on the urgency of the LLT.

Although FIG. 8 illustrates one example quick TXOP with DS solution 800, various changes may be made to FIG. 8. For example, while shown as a series of steps, various steps in FIG. 8 could overlap, occur in parallel, occur in a different order, occur any number of times, be omitted, or replaced by other steps.

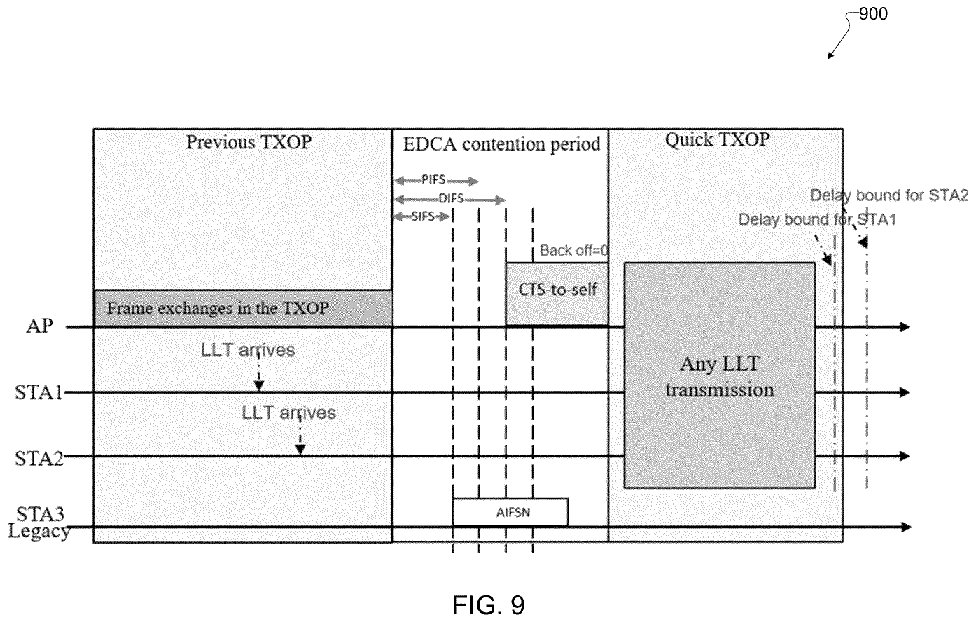

In some embodiments, an AP as a TXOP holder may decide to obtain a quick TXOP for any LLT. In some embodiments, a non-AP STA as a TXOP holder may indicate a quick TXOP request to an AP, such that the AP will help to reserve a quick TXOP later on. In some embodiments, an AP can send a CTS-to-self frame with the back-off as 0 after a DIFS to automatically win the channel access. A signaling example is shown in FIG. 9.

FIG. 9 illustrates an example of signaling and frame exchange for LLT with a quick TXOP 900 according to embodiments of the present disclosure. The embodiment of signaling and frame exchange of FIG. 9 is for illustration only. Different embodiments of signaling and frame exchange for LLT with a quick TXOP could be used without departing from the scope of this disclosure.

In the example of FIG. 9, LLT traffic arrives for a first STA (STA1) and a second STA (STA2) during a TXOP held by an AP. During an EDCA contention period following the TXOP, after a DIFS the AP sends a CTS-to-self frame with the back-off as 0 after a DIFS to automatically win the channel access. During a subsequent quick TXOP, the AP may trigger or share the TXOP for any kind of LLT.

Although FIG. 9 illustrates one example of signaling and frame exchange for LLT with a quick TXOP 900, various changes may be made to FIG. 9. For example, various changes to previous TXOP could be made, etc. according to particular needs.

In some embodiments, the TXOP holder can send other control frames such as an RTS, PS-poll, etc., right after the DIFS without contention, in which the backoff counter can be set to zero.

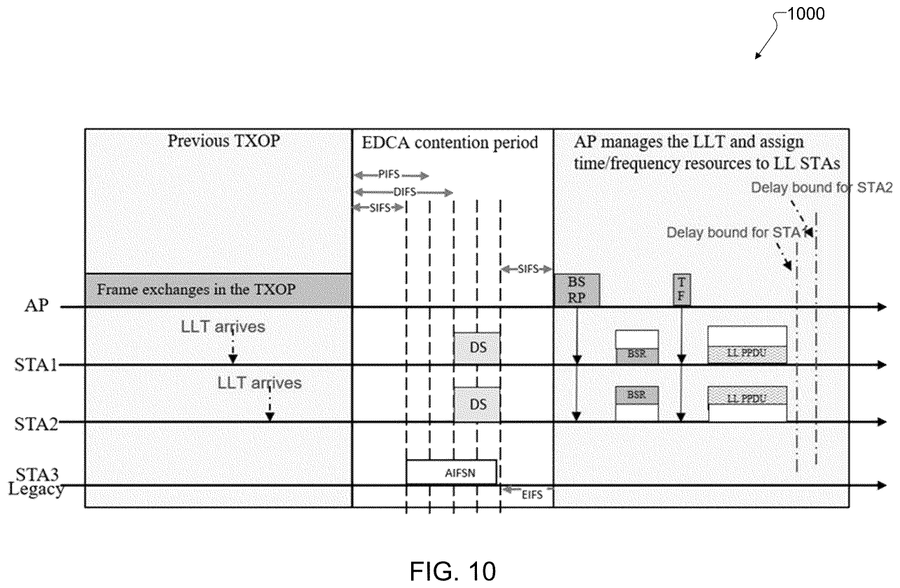

In some embodiments, the TXOP holder or the AP, when receiving the defer signals from LL STAs, may send a buffer status report poll (BSRP) after a SIFS to retrieve the BSR and LLT. In embodiments such as these, the AP may arrange the LLT for other STAs and itself to transmit within the delay bounds. A signaling example is shown in FIG. 10.

FIG. 10 illustrates an example of signaling and frame exchange 1000 for LLT with a quick TXOP and DS according to embodiments of the present disclosure. The embodiment of signaling and frame exchange of FIG. 10 is for illustration only. Different embodiments of signaling and frame exchange for LLT with a quick TXOP and DS could be used without departing from the scope of this disclosure.

In the example of FIG. 10, LLT traffic arrives for a first STA (STA1) and a second STA (STA2) during a TXOP held by an AP. During an EDCA contention period following the TXOP, after a DIFS, STA1 and STA2 each transmit a DS. Subsequently, after a SIFS, the AP sends a BSRP to retrieve the BSR and LLT from STA1 and STA2.

Although FIG. 10 illustrates one example of signaling and frame exchange 1000 for LLT with a quick TXOP and DS, various changes may be made to FIG. 10. For example, various changes to previous TXOP could be made, etc. according to particular needs.

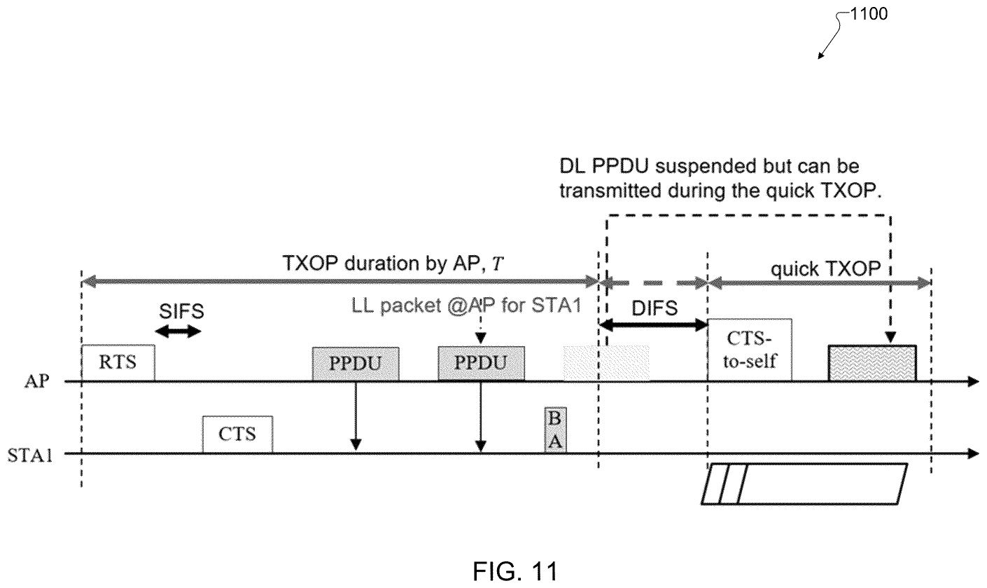

In some embodiments, when LLT is from the TXOP holder (to a TXOP responder, 3^{rd} parties, etc.), the TXOP holder can send a control frame such as a CTS-to-self, RTS, PS-poll, etc., right after a DIFS without contention, in which the backoff counter is set to zero, similar as shown in FIG. 11.

FIG. 11 illustrates an example of DL LLT 1100 in a quick TXOP according to embodiments of the present disclosure. The embodiment of DL LLT of FIG. 11 is for illustration only. Different embodiments of DL LLT in a quick TXOP could be used without departing from the scope of this disclosure.

In the example of FIG. 11, the AP is TXOP holder. The AP receives DL LLT for a STA (“STA1”) during the TXOP. After a DIFS without contention, the AP sends a CTS-to-self frame in which the backoff counter is set to zero, and transmits the DLL LLT for STA1 in a quick TXOP.

Although FIG. 11 illustrates one example of DL LLT 1100 in a quick TXOP, various changes may be made to FIG. 11. For example, various changes to the TXOP duration could be made, etc. according to particular needs.

In some embodiments, when the TXOP holder is a non-AP STA, the non-AP STA may send a CTS-to-AP frame to obtain a quick TXOP. In some embodiments, the AP can obtain the quick TXOP and schedule the LLT.

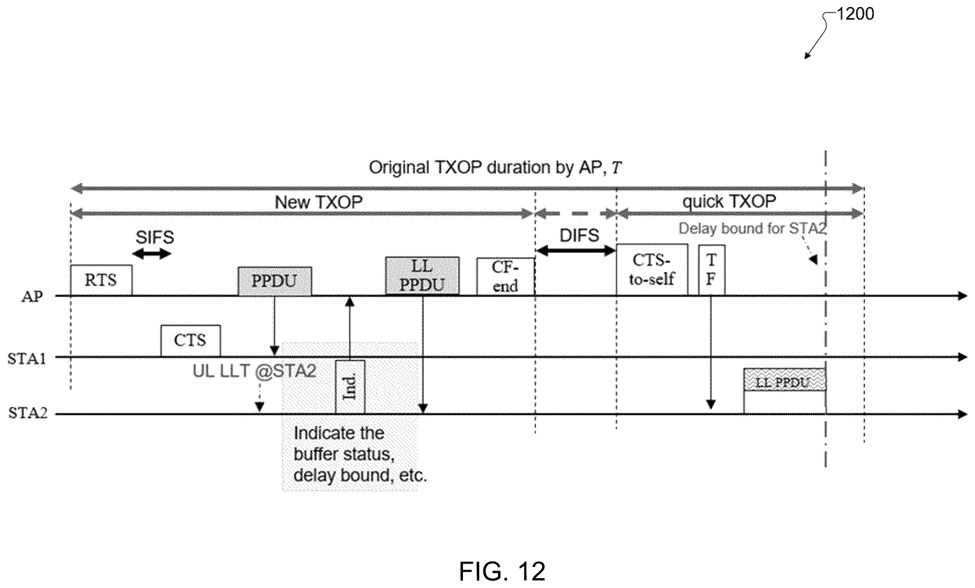

In some embodiments, when LLT is from the TXOP responder or 3^{rd} parties (e.g., UL LLT from a STA to AP, P2P from a first STA to a second STA, etc.), a quick TXOP request frame or LLT indication frame and a CTS-to-self frame can be transmitted, similar as shown in FIG. 12.

FIG. 12 illustrates an example of UL LLT 1200 in a quick TXOP according to embodiments of the present disclosure. The embodiment of DL LLT of FIG. 12 is for illustration only. Different embodiments of DL LLT in a quick TXOP could be used without departing from the scope of this disclosure.

In the example of FIG. 12, the AP is the TXOP holder. During the TXOP a second STA (“STA2”) receives UL LLT for a first STA (“STA1”) and transmits an LLT indication frame to the AP. After a DIFS without contention, the AP sends a CTS-to-self frame in which the backoff counter is set to zero, and transmits a trigger frame (TF) to STA2. STA2 then transmits the LLT in the TXOP.

Although FIG. 12 illustrates one example of UL LLT 1200 in a quick TXOP, various changes may be made to FIG. 12. For example, various changes to the TXOP duration could be made, etc. according to particular needs.

In some embodiments, an LL STA can indicate LLT to the TXOP holder during the TXOP (e.g., via quick a TXOP request, urgent request, preemption request frame) such that the TXOP holder may obtain a quick TXOP and trigger transmission of the LLT after a DIFS.

In some embodiments, the request frame may include the requestor's buffer status, delay bound, time information, etc.

In some embodiments, when a non-AP STA is a TXOP holder and the TXOP responder is an AP, the TXOP holder may send a CF-end frame to terminate the TXOP. The AP then may send a CTS-to-self frame by itself to activate the quick TXOP. In embodiments such as these the AP may be notified about the LLT in the first TXOP.

In some embodiments, an LL STA may set SCS with an AP to indicate a long term delay bound. For a short term or dynamic event, the AP could obtain the delay bound from the LL STA, and decide to send a CF-end frame to finish the first TXOP, and then obtain the quick TXOP.

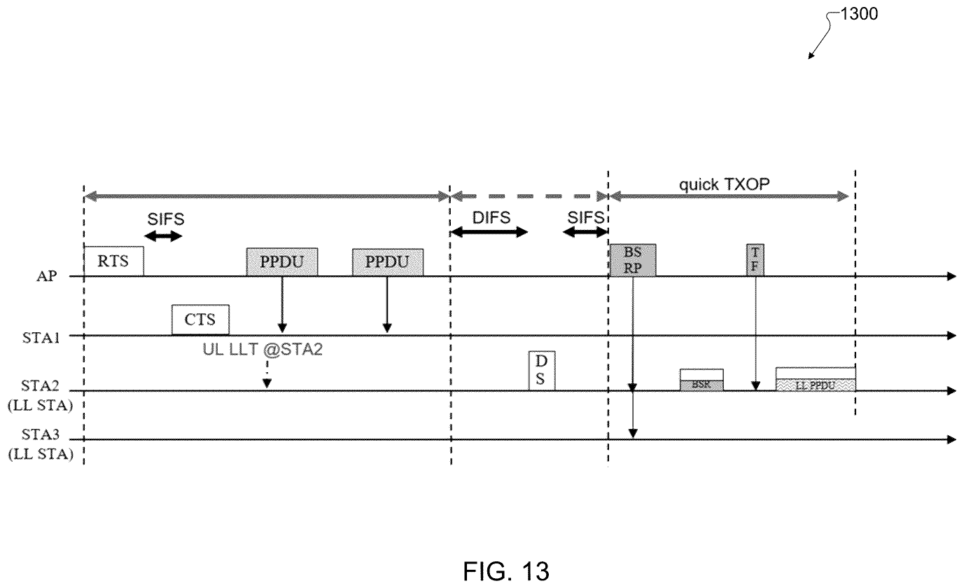

In some embodiments, LL STAs who may send a DS may have registered membership with the AP. The registered STAs with LLT may send the deter signals after a DIFS at the end of a TXOP. Then the AP may transmit trigger frames such as a BSRP with backoff equal to zero after a SIFS. Those registered UHR LL STAs then may report their buffers if they have the LLT and may be transmitted sooner (e.g., their delay bounds are within the quick TXOP limit). Those registered STAs who do not have LLT could choose to be silent. An example is shown in FIG. 13.

FIG. 13 illustrates an example of LLT 1300 in a quick TXOP according to embodiments of the present disclosure. The embodiment of LLT of FIG. 13 is for illustration only. Different embodiments of LLT in a quick TXOP could be used without departing from the scope of this disclosure.

In the Example of FIG. 13, an AP is transmitting traffic to a first station (“STA1”) during a TXOP held by the AP. During the TXOP, a second STA (“STA2”) which is an LL STA receives UL LLT for transmission. After a DIFS at the end of the TXOP, STA2 transmits a DS. After a SIFS, the AP transmits a BSRP frame to STA2 followed by a trigger frame, and STA2 transmits its LLT.

Although FIG. 13 illustrates one example of LLT 1300 in a quick TXOP, various changes may be made to FIG. 13. For example, various changes to the TXOP duration could be made, etc. according to particular needs.

In some embodiments, an AP may transmit a MU-RTS TXS for TXOP sharing if there is an urgent P2P indication. In some embodiments, the AP may assign resource units (RUs) to LL STAs, and those LL STAs may have specific association IDs (AIDs). In some embodiments, the AP may use random OFDMA random access (RORA) procedure such that the LL STAs may contend the RU.

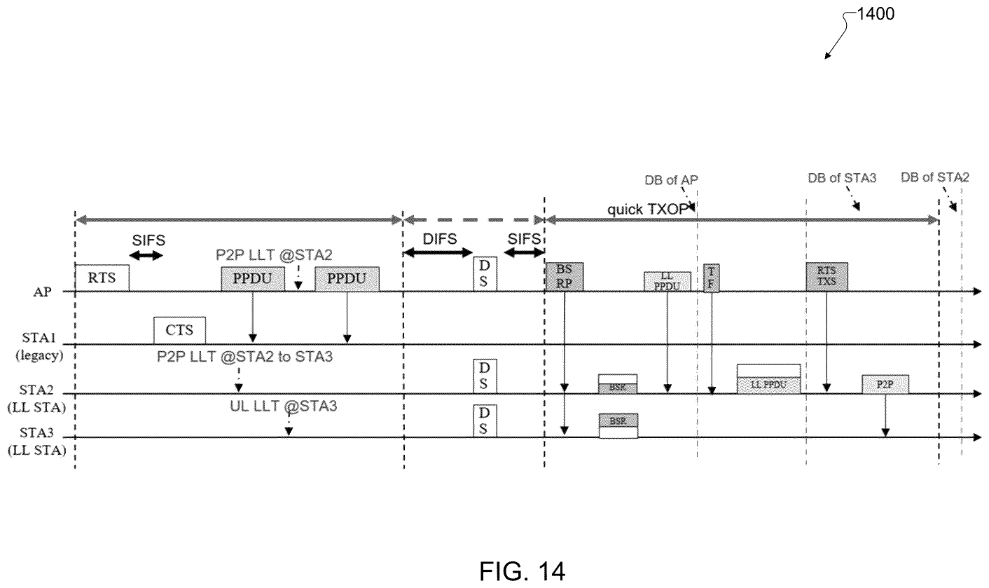

If the traffic directions and types are different (e.g., a first STA has urgent P2P for a second STA, the second STA has UL LLT for the AP, and the AP may have urgent DL to the first STA), then the AP could arrange the traffic based on the urgency (e.g., trigger UL to the second STA, assign TXOP MU-RTS TXS to the first STA), similar as shown in FIG. 14.

FIG. 14 illustrates an example of multiple types of LLT 1400 in a quick TXOP according to embodiments of the present disclosure. The embodiment of multiple types of LLT of FIG. 14 is for illustration only. Different embodiments of multiple types of LLT in a quick TXOP could be used without departing from the scope of this disclosure.

In the Example of FIG. 14, an AP is transmitting traffic to a first station (“STA1”) during a TXOP held by the AP. During the TXOP, a second STA (“STA2”) which is an LL STA receives P2P LLT for transmission to a third STA (“STA3”), STA3 receives UL LLT for transmission to the AP, and the AP has LLT for STA2. After a DIFS at the end of the TXOP, the AP, STA2, and STA3 transmits DSs. After a SIFS, the AP transmits a BSRP frame to STA2 and STA 3. The AP then transmits its LLT to STA2, followed by a trigger frame. The AP transmits an RTS TXS frame to STA2, and STA 2 transmits its P2P LLT to STA3.

Although FIG. 14 illustrates one example of multiple types of LLT 1400 in a quick TXOP, various changes may be made to FIG. 14. For example, various changes to the TXOP duration could be made, etc. according to particular needs.

In some embodiments, where the AP may also have LLT, if the AP does not receive a DS, it can transmit the LLT after sending a DS. If the AP also receives a DS, the AP may either transmit the LLT within the quick TXOP (e.g., at the end of the TXOP), or it can perform another round of contention if the AP's LLT is not as urgent as the LL STA's LLT.

In some embodiments, to avoid abusive extension or multiple quick TXOPs, the number of the quick TXOPs may be limited (e.g., only one-time extension may be allowed). In some embodiments, a maximum number of quick TXOPs may be specified.

In some embodiments, to avoid abusive extension or multiple quick TXOPs, the length of the extension can be specified (e.g., one or two frame or four frame exchanges).

In some embodiments, extension may be limited to ACs with higher user priority (UP). In some embodiments, extension may be limited to voice (VO), or VO and video (VI). The service priority can be considered based on the initiation or negotiation.

In some embodiments, if multiple quick TXOP requests are indicated, they can be scheduled on different frequencies based on the BSR.

In some embodiments, other STAs may detect the DIFS and if its backoff counter has a value of zero, which may result in a collision, but the probability is very low.

Various example use case categories for preemption are shown in Table 1. For example, case 1 is the case where the TXOP holder is the AP, the TXOP responder is STA1, and the transmission direction is DL from AP to STA1. The preemptor is an AP with LLT, and the LLT receiver is STA2. This case is described as TXOP holder preempts its own TXOP. Infra preempts infra.

TABLE 1
Use cases in preemption

| | | | DL/UL TXOP | | | | |
|---|---|---|---|---|---|---|---|
| | TXOP | TXOP | Traffic | Preemptor | LLT | LLT | |
| | holder | responder | direction | (LL STA) | receiver | Direction | Description |
| Case 1 | AP | STA1 | DL, AP → | AP | STA2 | DL, AP → | TXOP holder preempts its |
| | | | STA1 | | | STA2 | own TXOP. Infra preempts |
| | | | | | | | infra. |
| Case 2 | AP | STA1 | DL, AP → | STA2 | AP | UL, STA2 | 3^{rd} party preempts infra |
| | | | STA1 | | | → AP | |
| Case 3 | AP | STA1 | DL, AP → | STA2, | AP | UL, STA2 & | 3^{rd} party preempts infra. |
| | | | STA1 | STA3 | | STA3 → AP | |
| Case 4 | AP | STA1 | DL, AP → | STA1 | STA1 | P2P, STA2 | Non-infra (P2P) preempts |
| | | | STA1 | | | → STA1 | infra. |
| Case 5 | AP | STA1 | DL, AP → | STA1 | AP | UL, STA1 | TXOP responder preempts |
| | | | STA1 | | | → AP | TXOP holder. Reversed |
| | | | | | | | TXOP. |
| Case 6 | AP | STA1 | DL, AP → | STA1 | STA2 | P2P, STA1 | Non-infra (P2P) preempts |
| | | | STA1 | | | → STA2 | infra. |
| Case 7 | STA1 | AP | UL, STA1 → | STA1 | STA2 | P2P, STA1 | TXOP holder preempts its |
| | | | AP | | | → STA2 | own TXOP. Non-infra |
| | | | | | | | (P2P) preempts infra. |
| Case 8 | STA1 | AP | UL, STA1 → | STA2 | AP | UL, STA2 | 3^{rd} party preempts infra. |
| | | | AP | | | → AP | |
| Case 9 | STA1 | AP | UL, STA1 → | STA2, | AP | UL, STA2 & | 3^{rd} party preempts infra. |
| | | | AP | STA3 | | STA3 → AP | |
| Case 10 | STA1 | AP | UL, STA1 → | STA2 | STA1 | P2P, STA2 | Non-infra (P2P) preempts |
| | | | AP | | | → STA1 | infra. |
| Case 11 | STA1 | AP | UL, STA1 → | AP | STA2 | DL, AP → | Infra preempts infra. |
| | | | AP | | | STA2 | |
| Case 12 | STA1 | AP | UL, STA1 → | AP | STA1 | DL, AP → | TXOP responder preempts |
| | | | AP | | | STA1 | TXOP holder. Reversed |
| | | | | | | | TXOP. |
| Case 13 | AP | STA1 | UL trigger, | STA2 | AP | UL, STA2 | 3^{rd} party preempts infra. |
| | | | STA1 → AP | | | → AP | |
| Case 14 | AP | STA1 | UL trigger, | STA2 | STA1 | P2P, STA2 | Non-infra (P2P) preempts |
| | | | STA1 → AP | | | → STA1 | infra. |

The use cases in one BSS can be classified into the following main categories:
In general, a TXOP holder preempts its own TXOP.
3rd party(ies) preempt infra.
Non-infra (P2P) preempts infra.
TXOP responder preempts TXOP holder.

How many use cases can be considered depends on the following points:
The most prioritized cases may be considered.
Methods can be different from categories to categories and should not regress compared with the current performance.
Preempting ongoing traffic should also be careful in case of their QoS requirement.

The quick TXOP can solve most of the issues.

As noted above, various embodiments of the present disclosure provide mechanisms to reduce LLT backlog and long tail latency.

In some embodiments, an AP or a soft AP may prioritize the transmission for some prioritized STAs determinately during the high priority (Hip) EDCA contention window.

In some embodiments, the AP or a soft AP may prioritize the transmission for some prioritized STAs determinately during the high priority EDCA procedure or contention period. For example, the AP may contend the channel with a backoff counter setting to zero, or the AP may transmit a signal to access the channel directly after the defer signals.

In some embodiments, the AP may set a short duration less than the duration of a non-AP STA using P-EDCA to create prioritization for the AP.

In some embodiments, the AP may step in the prioritized EDCA contention after a pre-defined duration.

In some embodiments, the AP may end the P-EDCA contention after a duration. In embodiments such as these, the duration may be considered as a channel acquisition limit, or the maximum number of contention attempts.

In some embodiments, to help the LL STAs transmit determinately, the AP can prioritize the transmission for some prioritized STAs in which the delay bounds are approaching.

In some embodiments, AP managed deployment may support low latency traffic, and may be better complement with Hip EDCA for some use cases. In some embodiments, the AP may support the LLT when latency worse-case bounds are approaching and the LL STAs are urgently seeking opportunities to be scheduled before the bounds. In some embodiments, the AP may push the LL STAs into participating in an “immediate following TXOP”.

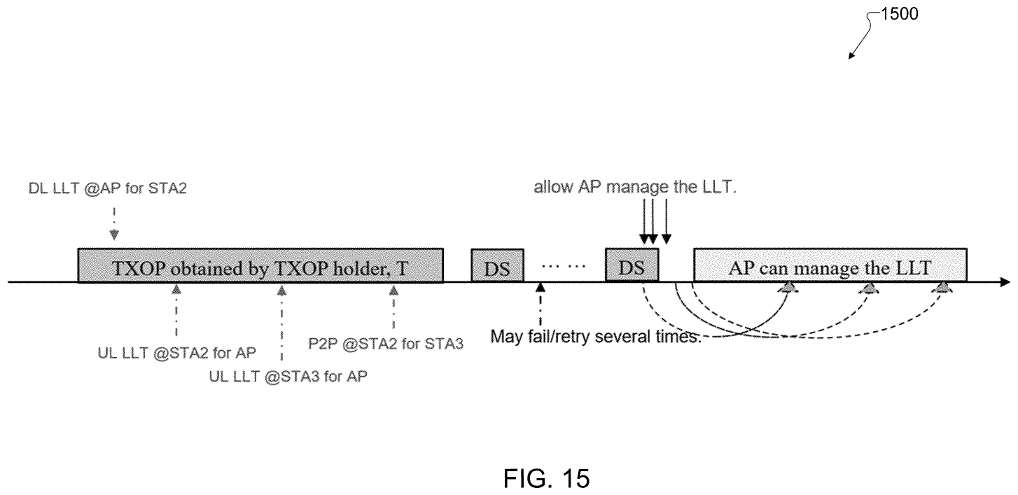

Hip EDCA with AP control or AP intervention or AP support may be referred to herein as Hip EDCA mode B. In some embodiments, Hip EDCA without the help of an AP can be referred to as Hip EDCA mode A. An example of Hip EDCA mode B is shown in FIG. 15.

FIG. 15 illustrates an example of Hip EDCA with AP control 1500 according to embodiments of the present disclosure. The embodiment of Hip EDCA with AP control of FIG. 15 is for illustration only. Different embodiments of Hip EDCA with AP control could be used without departing from the scope of this disclosure.

In the Example of FIG. 15, during a TXOP, multiple types of LLT arrive including DL LLT at an AP for “STA2”, UL LLT at STA2 for the AP, UL LLT at “STA3” for the AP, and P2P LLT at STA2 for STA3. After the TXOP, DSs are transmitted with several failures and retries. Due to the failures, the AP intervenes and takes over management of the LLT.

Although FIG. 15 illustrates one example of Hip EDCA with AP control 1500, various changes may be made to FIG. 15. For example, various changes to the AP management could be made, etc. according to particular needs.

In some embodiments, the AP intervention may be a method to recover Prioritized EDCA into normal EDCA.

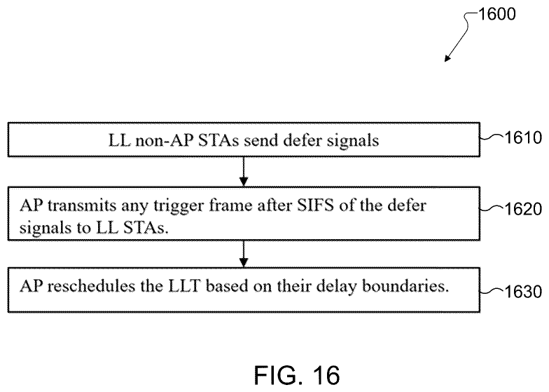

In some embodiments, a Hip EDCA mode B solution may be similar as shown in FIG. 16.

FIG. 16 illustrates an example method 1600 for a Hip EDCA mode B according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments a method for a Hip EDCA mode B could be used without departing from the scope of this disclosure.

In the Example of FIG. 16, method 1600 begins at step 1610. At step 1610, LL non-AP STAs send defer signals (DSs) in between several P-EDCA obtained TXOPs.

In some embodiments, the LL STAs may have registered with an AP in a membership such that the LL STAs can send the DSs.

In some embodiments, there is an LL session setup and tear down among the LL STAs such that the LL STAs may transmit the defer signals. In some embodiments, LL STAs and the AP may have negotiation phases before activating the Hip EDCA operation.

In some embodiments, STAs who do not register or do not support the Hip EDCA operation may not be able to send defer signals.

In some embodiments, an AP may not need to send defer signals when the AP has LLT. In embodiments such as these the AP may access the Hip EDCA by sending defer signals when the AP has LLT and the AP may not be allowed to access the Hip EDCA mode B. In some embodiments, the AP may need to maintain the LL session with the LL STAs such that the AP can keep monitoring the LL STAs needs and assist with mode B when the AP does not have LLT.

At step 1620, an AP transmits any trigger frame with the backoff counter equal to zero after SIFS of the DSs to the associated LL STAs, based on some conditions. The conditions of step 1620 may be as described herein.

After the non-AP STAs transmit the DSs, the AP can send any trigger frame after the SIFS to the registered LL STAs.

In some embodiments, the AP may send the trigger frames based on some conditions such as the worse-case latency bounds are approaching, multiple DSs colliding, etc. In some embodiments, the AP may directly send the trigger frame to support the LL STAs determinately with AP control.

In some embodiments, the AP may send a trigger frame with the backoff counter equal to zero after a SIFS after the DSs. The signaling may be as described herein.

In some embodiments, SIFS or PIFS can be considered as the duration of sending the trigger frame from AP. The Hip EDCA may require DIFS following DSs, and backoff start after the DIFS. The IFS less than DIFS would help AP to win the priority access TXOP.

At step 1630, during the new obtained TXOP, the AP reschedules the LLT based on their delay boundaries.

In some embodiments, The AP could send a trigger frame with backoff equal to zero to the LL STAs who have registered or are within the LL session period. For example, an uplink OFDM random access (UORA) trigger frame can be sent to the LL STAs, and one or more of the STAs sending a DS may contend the random access resource units (RARUs).

In some embodiments, the AP may send a BSRP to retrieve the buffer status and allocate resources accordingly.

In some embodiments, the AP may poll the traffic each by each. For example, the AP may share the TXOP one by one.

In some embodiments, the AP may first obtain some information from the LL STA, for example, the time information, the delay bound, buffer status, etc. The information may be exchanged via SCS, BSR, etc. Based on the information, when AP obtains a TXOP, the AP may consider to setup the first TXOP with a short length which is less or equal to the delay bound. When LLT arrives for an LL STA, the AP may then obtain a quick TXOP after the first TXOP. During the quick TXOP, the AP may trigger the LL STA for LLT transmission, the AP may also transmit the LLT to other STAs, the AP may share the TXOP for a P2P transmission, or co-ex transmission.

Although FIG. 16 illustrates one example method 1600 for a Hip EDCA mode B, various changes may be made to FIG. 16. For example, while shown as a series of steps, various steps in FIG. 16 could overlap, occur in parallel, occur in a different order, occur any number of times, be omitted, or replaced by other steps.

Conditions to consider Hip EDCA mode B may include the following embodiments.

In some embodiments, Hip EDCA mode B may be activated for a congested network with multiple prioritized access non-AP STAs (LL STAs), where a large number of LL STAs (over 10, over 100 etc.), have LLT requested to be scheduled or transmitted in a short duration or service period.

In some embodiments, Hip EDCA mode B may be activated if multiple failures or collision during the contention window are detected (for example, multiple times requesting EIFS protection from Hip EDCA mode A). In some embodiments, Hip EDCA mode B may be activated when a longer Channel Acquisition Time is detected. For example, if the time for acquisition of a channel is greater than a timeout of latency, Hip EDCA mode B can be activated by the AP. In some embodiments, an AP may detect excessive HIP EDCA contention attempts, such as STAs repeatedly enter HIP EDCA contention without successfully accessing the channel, and Hip EDCA mode B may be activated.

In some embodiments, a timeout of the channel acquisition time in the Hip EDCA may activate Hip EDCA mode B.

In some embodiments, the LL STAs may have reached the worse-case latency bounds and the AP may activate Hip EDCA mode B. The AP may be aware of the latency bounds from a dynamic BSR, SCS frame exchanges, etc.

When the AP has taken the TXOP many times among a higher number of other contenders, in some embodiments, the AP could just listen to the channel instead of sending the DS in next round to offer more chances to non-AP STAs, whether the AP has LLT or not.

In some embodiments, when the AP has no LLT and no DS is transmitted by AP, the AP could activate the Hip EDCA mode B to offer and manage scheduling to those LL STAs who fail multiple times during a service period. This can allow the transmission within the latency boundaries. If the AP sends the DS as mode A, in some embodiments, the AP could try to manage the LLT but there is no guarantee, and is dependent on the AP's implementation.

In some embodiments, where hidden nodes are present, (e.g., two LL STAs send DSs), the AP can help to manage and regulate if needed. For example, the AP can send a frame to synchronize the DSs.

In general, the AP can better utilize and manage the network during Hip EDCA operation, and balance the fairness among STAs and the AP.

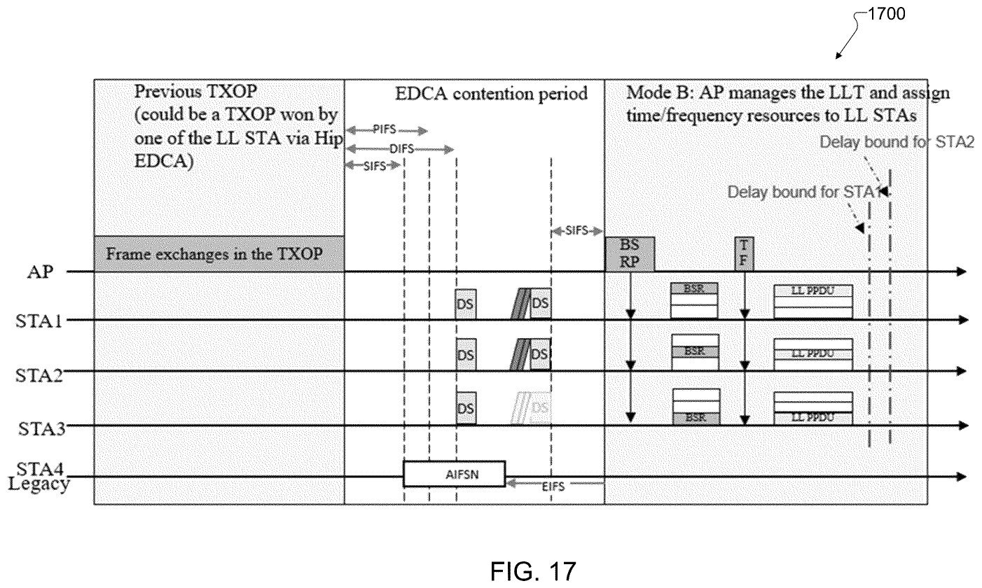

An illustration of the Hip EDCA mode B is shown in FIG. 17.

FIG. 17 illustrates an example of Hip EDCA mode B 1700 according to embodiments of the present disclosure. The embodiment of Hip EDCA mode B of FIG. 17 is for illustration only. Different embodiments of Hip EDCA mode B could be used without departing from the scope of this disclosure.

In the example of FIG. 17, after a TXOP, STA1 and STA2 send DSs and may backoff after the DIFS. Based on one or more of the considerations described herein, the AP may activate Hip EDCA mode B after SIFS of the DSs. After an EDCA contention period, the AP activates Hip EDCA mode B. In this example, the trigger frame for the Hip EDCA mode B is a BSRP, which is transmitted to retrieve the LL STA's buffers and to schedule the LLT within the delay bounds.

Although FIG. 17 illustrates one example of Hip EDCA mode B 1700, various changes may be made to FIG. 17. For example, various changes to the AP management could be made, etc. according to particular needs.

In some embodiments, LL non-AP STAs may send Defer Signals and start contending the channel. In embodiments such as these, after several rounds of competition with no results, or after a long “channel acquisition time limit”, or a long contention duration, the AP may step in by contending using P-EDCA, or the AP can send some trigger frame after SIFS/PIFS, (e.g., BSRP, UORA TF) to offer scheduling and provide management for the LLT.

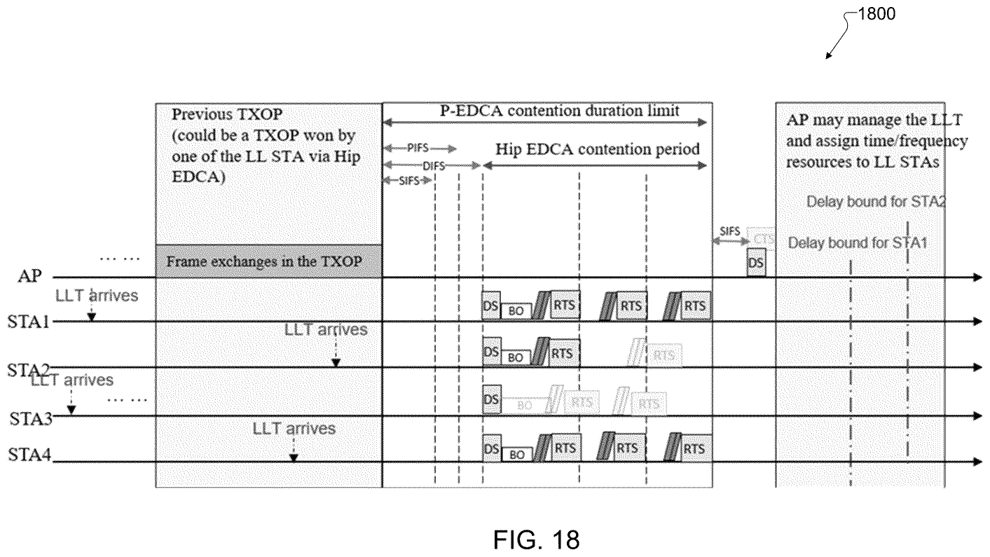

In some embodiments, the contention duration limit of the P-EDCA contention period can be defined as the maximum retry limit of contention, (e.g., times of sending RTS), plus the duration of starting DS (e.g., DIFS), plus the number of contention slots, similar as shown in FIG. 18.

FIG. 18 illustrates an example of a Hip EDCA contention period 1800 according to embodiments of the present disclosure. The embodiment of a Hip EDCA contention period of FIG. 18 is for illustration only. Different embodiments of a Hip EDCA contention period could be used without departing from the scope of this disclosure.

In the example of FIG. 18, After a TXOP several STAS (STA1, STA2, STA3, and STA4) contend for transmission of their LLT during a Hip EDCA contention period. The Hip contention period begins after the DIFS of the previous TXOP and ends at the P-EDCA contention duration limit.

Although FIG. 18 illustrates one example of a Hip EDCA contention period 1800, various changes may be made to FIG. 18. For example, various changes to the AP management could be made, etc. according to particular needs.

In some embodiments, the pre-defined duration limit may include a number of consecutive P-EDCA contention attempts. In embodiments such as these, the duration limit may be calculated based on the number N of consecutive contention attempts multiplied by the back off duration plus the duration of RTS, where the back off duration range is from CW_min to CW_max.

In some embodiments, the AIFSN value of P-EDCA contention duration for a non-AP STA may be set as 2, and the AIFSN value of P-EDCA contention duration for AP may be set as 1. In some embodiments, the P-EDCA contention duration is P-EDCA AIFS=AIFSN[AC]*aSlotTime+N*aSlotTime. In some embodiments, the AIFSN could be 2 for a non-AP STA, and the AIFSN could be 1 for an AP or soft AP. In some embodiments, N could be an integer from zero to 7. In some embodiments, the value of the P-EDCA AIFSN[AC] may be greater than or equal to 2 for non-AP STAs using P-EDCA. In some embodiments, the value of the P-EDCA AIFSN may be greater than or equal to 1 for APs using P-EDCA.

In some embodiments, the P-EDCA contention duration limit may be advertised by the AP.

In some embodiments, the AP may have its own LLT, and the AP may send a DS, and backoff as in Hip EDCA mode A.

In some embodiments, the AP may have its own LLT, but the AP may not send a DS, either for the reason of session tear down or that the AP would like to avoid contending since the AP has won the channel multiple times in a short period of duration and the latency bound is far.

In some embodiments, if the AP does not contend the P-EDCA, or the AP does not have LLT, the AP could offer scheduling or use P-EDCA if the contention duration exceeds the contention duration limit.

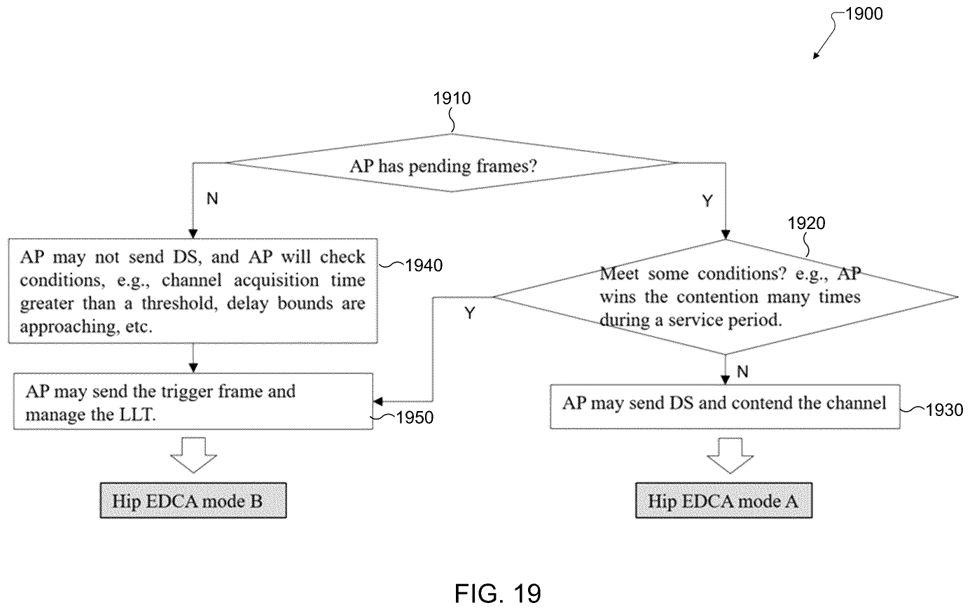

An example framework of the mode selection described herein is shown in FIG. 19.

FIG. 19 illustrates an example solution 1900 for Hip EDCA mode selection according to embodiments of the present disclosure. An embodiment of the solution illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a solution for Hip EDCA mode selection could be used without departing from the scope of this disclosure.

Solution 1900 begins at step 1910. At step 1910, an AP determines whether it has any pending frames for transmission. If the AP has pending frames, solution 1900 proceeds to step 1920. Otherwise, if the AP does not have pending frames, solution 1900 proceeds to step 1940.

At step 1920, the AP determines if any conditions are met (such as the AP has won contention many times during a service period). If any conditions are not met, solution 1900 proceeds to step 1930. Otherwise, if any conditions are met, solution 1900 proceeds to step 1950.

At step 1930, the AP may send a DS and contend the channel, activating Hip EDCA mode A.

At step 1940, the AP may not send a DS, and the AP checks conditions (such as channel acquisition time, delay bounds, etc.).

At step 1950, the AP may send a trigger frame and manage the LLT, activating Hip EDCA mode B.

Although FIG. 19 illustrates one example solution 1900 for Hip EDCA mode selection, various changes may be made to FIG. 19. For example, while shown as a series of steps, various steps in FIG. 19 could overlap, occur in parallel, occur in a different order, occur any number of times, be omitted, or replaced by other steps.

In some embodiments, the AP may offer scheduling by sending a trigger frame (e.g., a UORA trigger frame, BSRP frame with backoff equal to zero, etc.).

In some embodiments, the duration of the TXOP can be limited based on the maximum of the delay boundaries.

As described herein, the Hip TXOP limit refers to the TXOP that the AP provides during the Hip EDCA.

In some embodiments, an STA or an unregistered LL STA or a STA that has torn down the LL session will be in EIFS mode.

In some embodiments, registered LL STAs may send a DS if the registered LL STA has failed one or multiple times in previous TXOPs.

In some embodiments, if a STA sends a DS but does not win the channel, and the STA receives a trigger frame from AP, the STA can respond. Registered UHR LL STAs then may report their buffers or contend the RARU if they have LLT and should be scheduled sooner (e.g., their delay bounds are within the Hip TXOP limit).

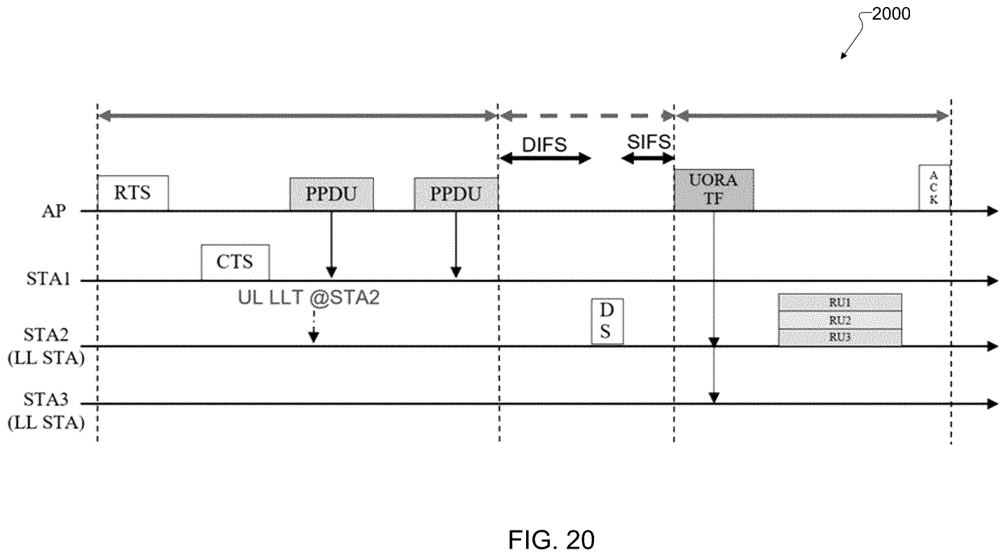

In some embodiments, registered UHR LL STAs with LLT may send DSs, and then the AP then after SIFS may transmit a trigger frame (e.g., UORA procedure with backoff counter equal to zero) after a SIFS, similar as shown in FIG. 20. In embodiments such as these The registered UHR LL STAs then may report their buffers or contend the RARU if they have LLT and should be scheduled sooner (e.g., their delay bounds are within the Hip TXOP limit). The registered STAs who do not have pending LL frames could choose to be silent and do not need to contend for an eligible RARU.

FIG. 20 illustrates an example 2000 of Hip EDCA mode B with a single DS according to embodiments of the present disclosure. The embodiment of Hip EDCA mode B of FIG. 20 is for illustration only. Different embodiments of Hip EDCA mode B could be used without departing from the scope of this disclosure.

In the example of FIG. 20, during a TXOP held by the AP, STA2 receives UL LLT for transmission to the AP. After the TXOP ends, STA2 transmits a DS after the DIFS. The AP transmits a UORA trigger frame, and STA2 transmits its LLT.

Although FIG. 20 illustrates one example 2000 of Hip EDCA mode B with a single DS, various changes may be made to FIG. 20. For example, various changes to the AP management could be made, etc. according to particular needs.

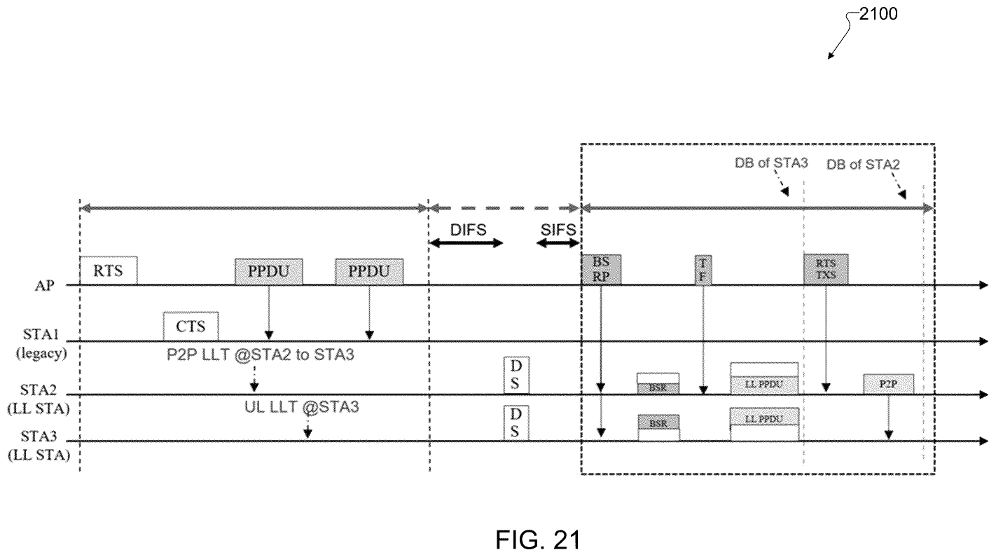

If the traffic directions are different (e.g., a first STA has urgent P2P for a second STA, and the first STA/second STA has UL LLT for the AP) then the AP in mode B could better arrange the traffic based on the delay boundaries compared with contention-based access (e.g., triggered UL to STA2 and STA3, and assigning MU-RTS TXS mode 2 to STA2) similar as shown in FIG. 21.

FIG. 21 illustrates an example of Hip EDCA mode B with a multiple DSs 2100 according to embodiments of the present disclosure. The embodiment of Hip EDCA mode B of FIG. 21 is for illustration only. Different embodiments of Hip EDCA mode B could be used without departing from the scope of this disclosure.

In the example of FIG. 21, during a TXOP held by the AP, STA2 receives P2P LLT for transmission to STA3, and STA3 receives UL LLT for transmission to the AP. After the TXOP ends, STA2 and STA3 each transmit a DS after the DIFS. After the SFIFS, the AP transmits a BSRP and receives BSRs from STA1 and STA2. AP transmits a trigger frame and STA2 and STA3 transmit UL LLT to the AP. The AP then sends an RTS TXS to STA2, after which STA2 transmits its P2P LLT to STA3.

Although FIG. 21 illustrates one example of Hip EDCA mode B with multiple DSs 2100, various changes may be made to FIG. 21. For example, various changes to the AP management could be made, etc. according to particular needs.

As described herein, Hip EDCA mode B provides for enhancement of channel access delay, such that AP managed deployment may improve latency in wireless networks Especially, in very congested scenarios with low latency traffic, the AP may obtain an “immediate following TXOP” such that multiple STAs with prioritized access and different types of traffic can be scheduled and arranged before latency worse-case bounds.

In some embodiments, STAs who may reach the delay bounds may start the P-EDCA by sending a DS.

In some embodiments, assuming the delay bound duration is y milliseconds, and the P-EDCA contention duration limit is x milliseconds, the P-EDCA may be enabled before y milliseconds plus the time of MSDU arrival from LLC, or y milliseconds plus the time of MSDU arrival from LLC plus a TXOP limit. In embodiments such as these, the STA may consider enabling the P-EDCA such that y is greater than x.

If y is smaller than x, in some embodiments the STA may still enable P-EDCA. In some embodiments, the STA may indicate to the AP. In some embodiments, the STA may not enable P-EDCA.

In some embodiments, STAs may start P-EDCA if a STA reaches the limit of a retransmission counter. For example, in some embodiments, a UHR STA who contended the channel for 2 or 3 or 4 times but is not able to obtain the channel, may enable the P-EDCA.

In some embodiments, the number of the retransmission counter may be advertised by AP in a beacon or probe response frame. In some embodiments, a default number of the retransmission counter for all UHR STAs enabling P-EDCA may be set as, for example, 2.

In some embodiments, if a STA does not send a DS but receives a trigger frame from the AP, the STA cannot contend the channel even if the STA has pending LL frames. Rin some embodiments, registered STAs who do not have or who may have pending LL frames could choose silence and may not need to contend for an eligible RARU.

In some embodiments a STA using P-EDCA may be disabled or may return back to normal EDCA contention according to the following one or more conditions:
If the P-EDCA contention duration reaches the limit of the P-EDCA contention period. In some embodiments, the duration can be a pre-defined duration limit. In some embodiments, the duration limit may be calculated as N*(CW_max+RTS_duration), in which N is the contention attempts (for example the number is greater than 5 times).
If the STA may send DS consecutively more than several times, e.g., 2 or 3.
If the P-EDCA contention duration reaches the limit of the P-EDCA contention period and the STA reaches the limit of a retry counter.
If the STA may send a DS consecutively more than some number, then the AP may access the channel using P-EDCA mode 2 and or by setting AIFSN=1.

In some embodiments, the transmission of the AP may also perform a synchronization purpose either for a next P-EDCA contention attempt or for normal EDCA, in some cases such as an RTS timeout.

In some embodiments, the number of the DS retry counter may be advertised by the AP in a beacon or probe response frame.

In some embodiments, a default number of the DS retry counter for all UHR STAs disabling the P-EDCA may be set as, for example, 2.

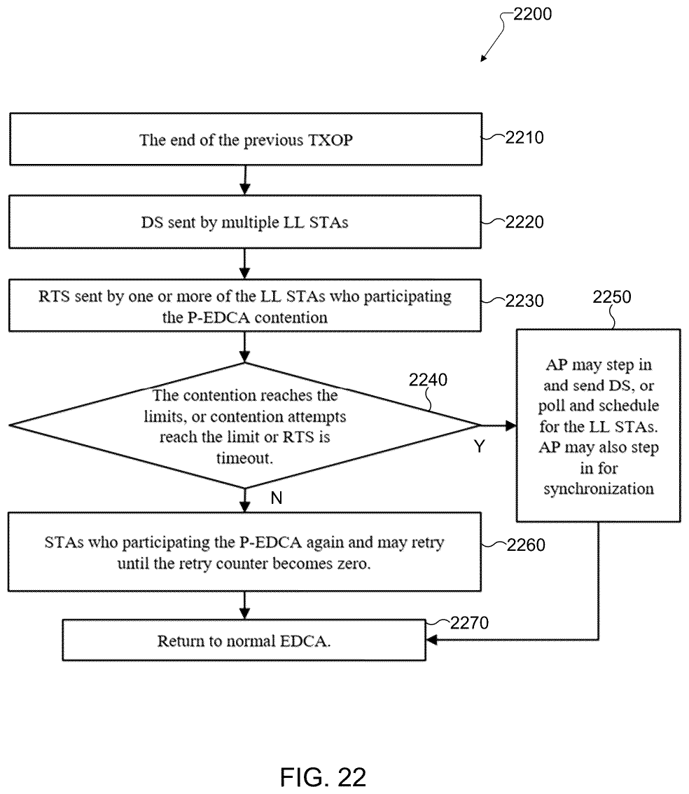

An example process for P-EDCA disablement is shown in FIG. 22.

FIG. 22 illustrates an example P-EDCA disablement solution 2200 according to embodiments of the present disclosure. An embodiment of the solution illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a P-EDCA disablement solution could be used without departing from the scope of this disclosure.

Solution 2200 begins at step 2210. At step 2210, a previous TXOP ends.

At step 2220, multiple LL STAs send a DS.

At step 2230, an RTS is sent by one or more of the LL STAs participating in the P-EDCA contention.

At step 2240, if the contention reaches its limits, or the contention attempts reach the limit, or the RTS times out, the solution 2200 proceeds to step 2250. Otherwise, solution 200 proceeds to step 2260.

At step 2250, the AP may step in and send a DS, or poll and schedule the LL STAs. The AP may also step in for synchronization.

At step 2260, the STAS participating in the P-EDCA may rerun until the counter becomes zero.

At step 2270, normal EDCA resumes.

Although FIG. 22 illustrates one example P-EDCA disablement solution 2200, various changes may be made to FIG. 22. For example, while shown as a series of steps, various steps in FIG. 22 could overlap, occur in parallel, occur in a different order, occur any number of times, be omitted, or replaced by other steps.

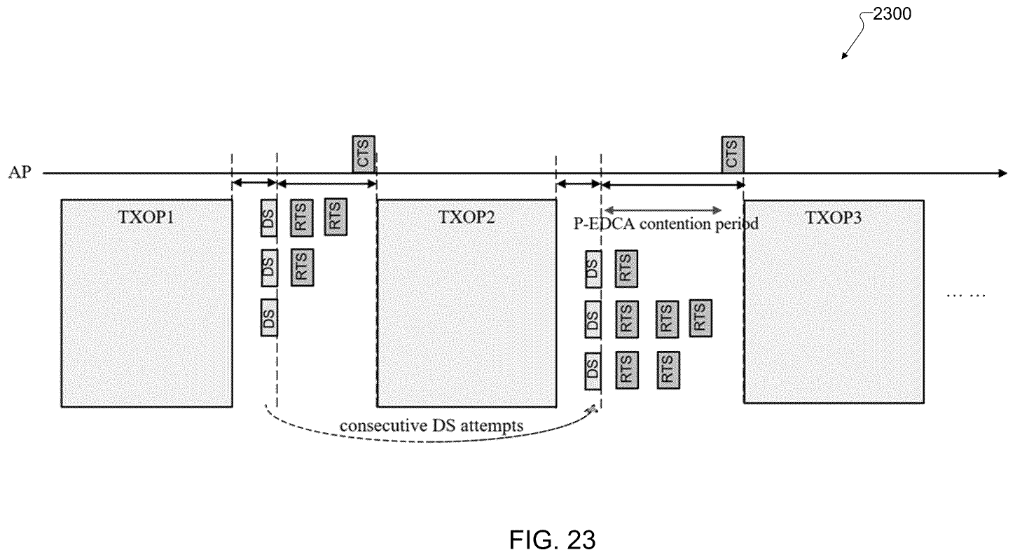

An example of AP intervention conditions are shown in FIG. 23.

FIG. 23 illustrates an example of consecutive DS attempts and a P-EDCA contention period 2300 according to embodiments of the present disclosure. The embodiment of DS attempts of FIG. 23 is for illustration only. Different embodiments of consecutive DS attempts and a P-EDCA contention period could be used without departing from the scope of this disclosure.

In the example of FIG. 23, after TXOP1, several DSs transmitted. After TXOP2, consecutive DSs are transmitted, indicating the first contention attempt failed. At this stage, the AP may determine to activate Hip EDCA mode B to manage the LLT.

Although FIG. 23 illustrates one example of consecutive DS attempts and a P-EDCA contention period 2300, various changes may be made to FIG. 23. For example, various changes to the P-EDCA contention period could be made, etc. according to particular needs.

An alternative to schedule the LLT is to extend the current TXOP for a short period of time. One solution to is to use RTS/CTS with fragmentation (Or Virtual RTS/CTS) to realize the on-the-fly TXOP extension.

In some embodiments, RTS/CTS may be used for a fragmented MSDU or MMPDU. The RTS/CTS frames define the duration of the following frame and acknowledgment. In some embodiments, the Duration/ID field in the Data and Ack frames specify the total duration of the next fragment and acknowledgment.

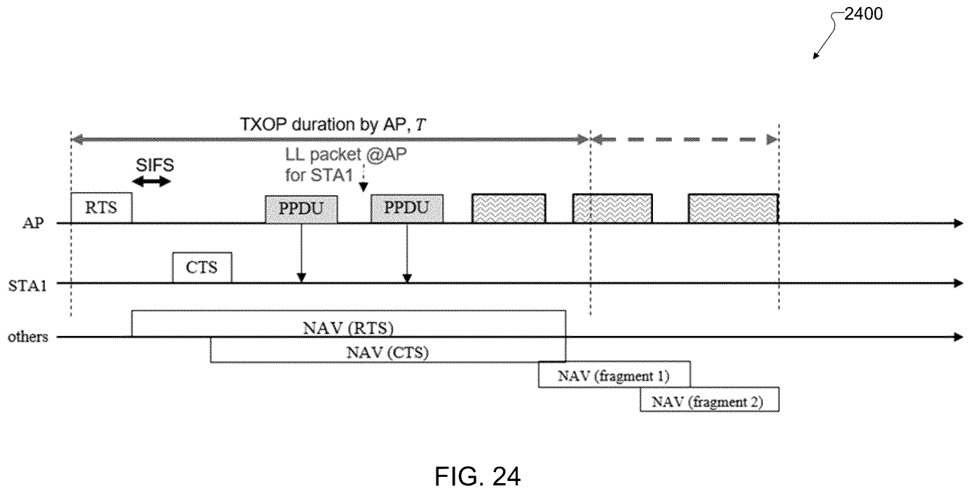

Dynamic fragmentation can be modified as an extension of the TXOP. For example, the LLT can be built into A-MSDU. In some embodiments, one the LLT arrives late, the LLT can be constructed into A-MSDU fragmentation, such that the duration can be updated in each fragment, such as shown in FIG. 24.

FIG. 24 illustrates an example of TXOP extension 2400 using dynamic fragmentation according to embodiments of the present disclosure. The embodiment of TXOP extension of FIG. 24 is for illustration only. Different embodiments of TXOP extension using dynamic fragmentation could be used without departing from the scope of this disclosure.

In the example of FIG. 24, during a TXOP held by the AP, the AP receives LLT for a STA (“STA1”). The AP extends the TXOP to permit transmission of the LLT to station 1 by using dynamic fragmentation procedures discussed herein.

Although FIG. 24 illustrates one example of TXOP extension 2400 using dynamic fragmentation, various changes may be made to FIG. 24. For example, various changes to TXOP duration could be made, etc. according to particular needs.

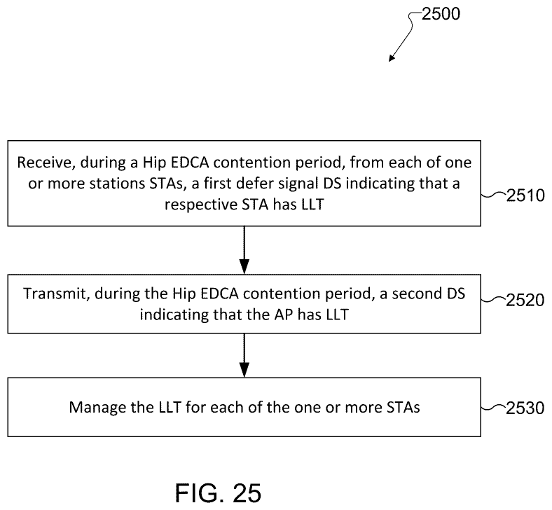

FIG. 25 illustrates an example method 2500 for Hip EDCA with AP support according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a method for Hip EDCA with AP support could be used without departing from the scope of this disclosure.

In the example of FIG. 25, method 2500 begins at step 2510. At step 2510, an AP (such as any of the APs shown in FIGS. 15, 17, 18, 20, 21, and 23) receives, during a during a Hip EDCA contention period, from each of one or more stations STAs (such as any of the STAs shown in FIGS. 15, 17, 18, 20, 21, and 23), a respective first defer signal DS indicating that a respective STA has LLT. In some embodiment, the first DS may be a control frame. In some embodiments, the control frame may be a clear to send (CTS) frame.

At step 2520, the UE transmits, during the transmits, during the Hip EDCA contention period, a second DS indicating that the AP has LLT. In some embodiment, the second DS may be a control frame. In some embodiments, the control frame may be a clear to send (CTS) frame.

At step 2530, the UE manages the LLT for each of the one or more STAs.

In some embodiments, the AP may detect or satisfy a condition. In embodiments such as these, the UE may manage the LLT for each of the one or more STAs in response to the detection or satisfaction of the condition.

In some embodiments, managing the LLT for each of the one or more STAs may include contending with the one or more using prioritized-EDCA (P-EDCA). In some embodiments, the condition may be at least more than one round of attempt among the one or more STAs during the Hip EDCA contention period. In some embodiments, the condition may be between one and three rounds of attempt among the one or more STAs during the Hip EDCA contention period.

In some embodiments, to manage the LLT for each of the one or more STAs, the AP may (i) determine a prioritization of the LLT for each of the one or more STAs, and (ii) based on the prioritization, transmit, after a SIFS or DIFS of each first DS, one or more trigger frames, each of the one or more trigger frames triggering at least one of the one or more STAs to transmit a respective LL PPDU.

In some embodiments, the AP may (i) transmit a third DS during the Hip contention period; and (ii) transmit a trigger frame scheduling OFDMA for transmission of a respective LL PPDU for at least one of the one or more STAs from which a first DS was received that supports P-EDCA.

Although FIG. 25 illustrates one example method 2500 for Hip EDCA with AP support, various changes may be made to FIG. 25. For example, while shown as a series of steps, various steps in FIG. 25 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An access point (AP) comprising:
a transceiver configured to at least one of:
receive, during a high priority (Hip) enhanced distributed channel access (EDCA) contention period, from each of one or more stations (STAs), a respective first defer signal (DS) indicating that a respective STA has low latency traffic (LLT); and
transmit, during the Hip EDCA contention period, a second DS indicating that the AP has LLT; and
a processor operably coupled to the transceiver, the processor configured manage the LLT for each of the one or more STAs.

2. The AP of claim 1 wherein the at least one of the first DS and the second DS is a control frame.

3. The AP of claim 2 wherein the control frame is a clear to send (CTS) frame.

4. The AP of claim 1, wherein the processor is further configured to:
detect or satisfy a condition; and
manage the LLT for each of the one or more STAs in response to detection or satisfaction of the condition.

5. The AP of claim 4, wherein to manage the LLT for each of the one or more STAs, the processor is further configured to contend with the one or more STAs using prioritized-EDCA (P-EDCA).

6. The AP of claim 4, wherein the condition is at least more than one round of attempt among the one or more STAs during the Hip EDCA contention period.

7. The AP of claim 4, wherein the condition is between one and three rounds of attempt among the one or more STAs during the Hip EDCA contention period.

8. The AP of claim 7, wherein to manage the LLT for each of the one or more STAs, the processor is further configured to:
determine a prioritization of the LLT for each of the one or more STAs; and
based on the prioritization, cause the transceiver to transmit, after a short interframe space (SIFS) or distributed coordination function (DCF) interframe space (DIFS) of each first DS, one or more trigger frames, each of the one or more trigger frames triggering at least one of the one or more STAs to transmit a respective low latency (LL) physical layer protocol data unit (PPDU).

9. The AP of claim 4, wherein the processor is further configured to cause the transceiver to at least one of:
transmit a third DS during the Hip EDCA contention period; and
transmit a trigger frame scheduling orthogonal frequency division multiple access (OFDMA) for transmission of a respective LL PPDU for at least one of the one or more STAs from which a first DS was received that supports prioritized-EDCA (P-EDCA).

10. A station (STA) comprising:
a processor; and
a transceiver operably coupled to the processor, the transceiver configured to at least one of:
transmit, during a high priority (Hip) enhanced distributed channel access (EDCA) contention period, a respective first defer signal (DS) indicating that the STA has low latency traffic (LLT); and
receive, during the Hip EDCA contention period, a second DS indicating that an access point (AP) has LLT.

11. The STA of claim 10 wherein at least one of the first DS and the second DS is a control frame.

12. The STA of claim 11 wherein the control frame is a clear to send (CTS) frame.

13. The STA of claim 11, wherein the processor is configured to contend with the AP and one or more other STAs using prioritized-EDCA (P-EDCA) in response to detection or satisfaction of a condition by the AP.

14. The STA of claim 13, wherein the condition is at least more than one round of attempt among the STA and the one or more other STAs during the Hip EDCA contention period.

15. The STA of claim 13, wherein the condition is between one and three rounds of attempt among the STA and the one or more other STAs during the Hip EDCA contention period.

16. The STA of claim 15, wherein the transceiver is further configured to:
receive, after a short interframe space (SIFS) or distributed coordination function (DCF) interframe space (DIFS) of the first DS, a trigger frame triggering the STA to transmit a low latency (LL) physical layer protocol data unit (PPDU).

17. The STA of claim 11, wherein:
the STA supports prioritized-EDCA (P-EDCA); and
the transceiver is further configured to:
receive a third DS during the Hip EDCA contention period; and
receive a trigger frame scheduling orthogonal frequency division multiple access (OFDMA) for transmission of a low latency (LL) physical layer protocol data unit (PPDU).

18. A method of operating an access point (AP), the method comprising:
at least one of:
receiving, during a high priority (Hip) enhanced distributed channel access (EDCA) contention period, from each of one or more stations (STAs), a respective first defer signal (DS) indicating that a respective STA has low latency traffic (LLT); and
transmitting, during the Hip EDCA contention period, a second DS indicating that the AP has LLT; and
managing the LLT for each of the one or more STAs.

19. The method of claim 18, further comprising detecting or satisfying a condition, wherein the LLT for each of the one or more STAs is managed in response to the detection or satisfaction of the condition.

20. The method of claim 19, wherein managing the LLT for each of the one or more STAs comprises contending with the one or more STAs using prioritized-EDCA (P-EDCA).
